(19) United States
(12) Patent Application Publication
(10) Pub. No.: US 2026/0295913 A1
(43) Pub. Date: Oct. 1, 2026

(54) INJECTION MOLDING APPARATUS AND INJECTION UNIT

(71) Applicant: SEIKO EPSON CORPORATION, Tokyo (JP)

(72) Inventors: Masashi FUCHII, MINOWA-MACHI (JP); Riona TODA, SHIOJIRI-SHI (JP); Kenta ANEGAWA, MATSUMOTO-SHI (JP)

(73) Assignee: SEIKO EPSON CORPORATION, Tokyo (JP)

(21) Appl. No.: 19/575,940

(22) Filed: Mar. 24, 2026

(30) Foreign Application Priority Data
Mar. 26, 2025 (JP) 2025-051130

(51) Int. Cl. B29C 45/76; B29C 45/46; B29C 45/77; B29C 45/78

(52) U.S. Cl. CPC B29C 45/7646; B29C 45/46; B29C 45/77; B29C 45/78; B29C 2945/76006; B29C 2945/7604; B29C 2945/7605

(57) ABSTRACT

An injection molding apparatus includes: an injection unit configured to inject a material of a molded article into a mold; a mold opening and closing unit to which the mold is attached and that opens and closes the mold; and a control unit configured to control the injection unit and the mold opening and closing unit. The injection unit includes a plasticizing unit that plasticizes the material, a flow path that communicates with the plasticizing unit and through which the plasticized material flows, an injector that injects the material in the flow path into the mold, a temperature measurement unit that is at least partially exposed in the flow path and measures a temperature of the material, and a pressure measurement unit that is at least partially exposed in the flow path and measures a pressure of the material.

### CROSS-REFERENCE TO RELATED APPLICATION

The present application is based on, and claims priority from JP Application Serial Number 2025-051130, filed Mar. 26, 2025, the disclosure of which is hereby incorporated by reference herein in its entirety.

### BACKGROUND

### 1. Technical Field

The present disclosure relates to an injection molding apparatus and an injection unit.

### 2. Related Art

JP-A-2023-154156 discloses that, in an injection molding apparatus including a plunger, a plurality of measurement units are provided outside a cylinder in order to measure temperatures and pressures at a plurality of locations in the cylinder in which the plunger reciprocates.

JP-A-2023-154156 is an example of the related art.

When a plurality of measurement units are provided to measure temperatures and pressures of a material flowing in a flow path, a technique capable of accurately measuring the temperatures and the pressures is desired.

### SUMMARY

According to a first aspect of the present disclosure, there is provided an injection molding apparatus that performs injection molding of a molded article using a mold. The injection molding apparatus includes: an injection unit configured to inject a material of the molded article into the mold; a mold opening and closing unit to which the mold is attached and that opens and closes the mold; and a control unit configured to control the injection unit and the mold opening and closing unit, in which the injection unit includes a plasticizing unit that plasticizes the material, a flow path that communicates with the plasticizing unit and through which the plasticized material flows, an injector that injects the material in the flow path into the mold, a temperature measurement unit that is at least partially exposed in the flow path and measures a temperature of the material, and a pressure measurement unit that is at least partially exposed in the flow path and measures pressure of the material, and at least a part of a region in which the temperature measurement unit virtually extends in the flow path and at least a part of a region in which the pressure measurement unit virtually extends in the flow path overlap each other in the flow path.

According to a second aspect of the present disclosure, there is provided an injection unit. The injection unit includes: a plasticizing unit configured to plasticize a material; a flow path that communicates with the plasticizing unit and through which the plasticized material flows; an injector configured to inject the material in the flow path into a mold; a temperature measurement unit that is at least partially exposed in the flow path and is configured to measure a temperature of the material; and a pressure measurement unit that is at least partially exposed in the flow path and is configured to measure pressure of the material, in which at least a part of a region in which the temperature measurement unit virtually extends in the flow path and at least a part of a region in which the pressure measurement unit virtually extends in the flow path overlap each other in the flow path.

### BRIEF DESCRIPTION OF THE DRAWINGS

FIG. 1 is a perspective view illustrating a schematic configuration of an injection molding apparatus.

FIG. 2 is a cross-sectional view illustrating a schematic configuration of an injection unit.

FIG. 3 is a perspective view illustrating a schematic configuration of a screw.

FIG. 4 is a schematic plan view illustrating a barrel.

FIG. 5 is a perspective one-side cross-sectional view illustrating an internal structure of the injection unit.

FIG. 6 is a view illustrating an arrangement of a temperature measurement unit and a pressure measurement unit.

FIG. 7 is a view illustrating a configuration of a fixing portion for fixing the temperature measurement unit.

FIG. 8 is a view illustrating a configuration of the fixing portion for fixing the temperature measurement unit.

FIG. 9 is a diagram illustrating an example of a measurement result of a temperature and pressure of a plasticized material.

FIG. 10 is a flowchart illustrating parameter setting processing.

FIG. 11 is a diagram illustrating a control pattern of feedback control.

### DESCRIPTION OF EMBODIMENTS

### A. First Embodiment

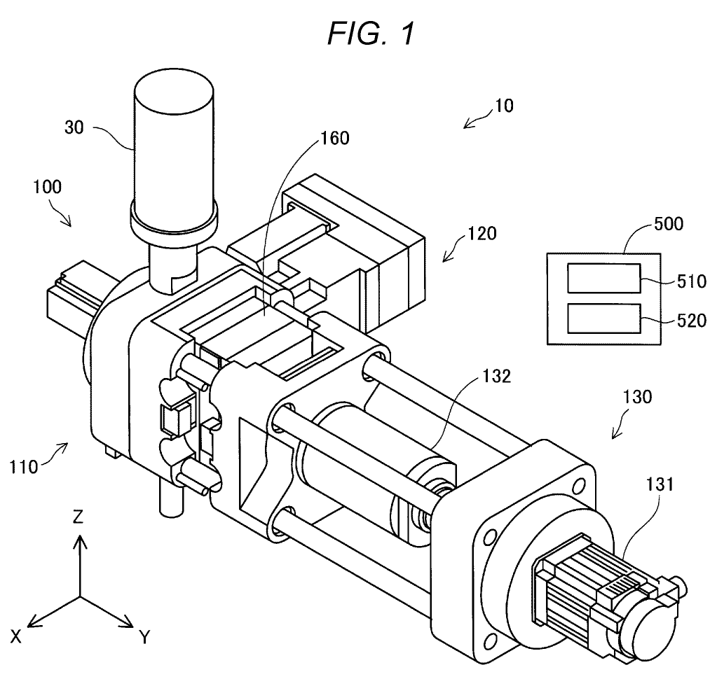

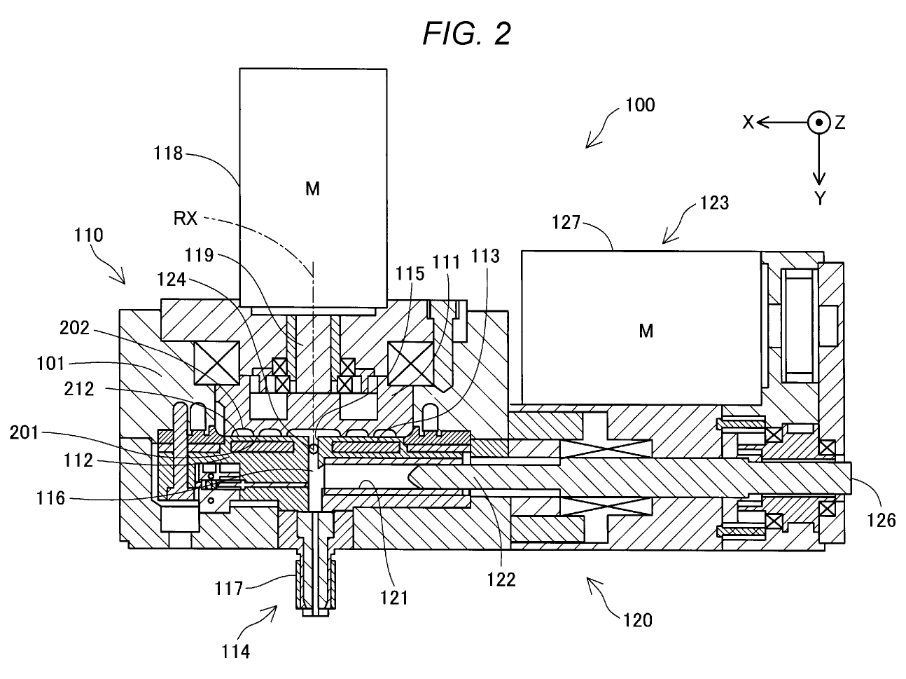

FIG. 1 is a perspective view illustrating a schematic configuration of an injection molding apparatus 10. The injection molding apparatus 10 is an apparatus that performs injection molding of a molded article using a mold 160. FIG. 1 illustrates arrows indicating X, Y, and Z directions orthogonal to one another. The X direction and the Y direction are directions parallel to a horizontal plane, and the Z direction is a direction along a vertical direction. X, Y, and Z directions illustrated in FIG. 2 and subsequent drawings correspond respectively to the X, Y, and Z directions illustrated in FIG. 1. In the following description, when a direction is specified, both positive and negative signs are used in the description of the direction, in which "+" refers to a positive direction that is a direction indicated by an arrow, and "-" refers to a negative direction that is an opposite direction to the direction indicated by the arrow. A +Z direction is a vertically upward direction, and a -Z direction is a vertically downward direction. The vertically upward direction is a direction opposite to the vertically downward direction. The vertically downward direction is a direction in which gravity acts, and is also referred to as the direction of gravity. Hereinafter, the vertically upward direction is simply referred to as "above", and the vertically downward direction is simply referred to as "below".

The injection molding apparatus 10 includes an injection unit 100, a mold opening and closing unit 130, and a control unit 500. The control unit 500 controls the injection unit 100 and the mold opening and closing unit 130. The control unit 500 is implemented by a computer including a CPU 510 and a storage unit 520. When the CPU 510 executes a program stored in the storage unit 520, the control unit 500 controls the injection unit 100 and the mold opening and closing unit 130. The control unit 500 may be implemented by a circuit.

The mold 160 is attached to the mold opening and closing unit 130. The mold opening and closing unit 130 is a unit that opens and closes the mold 160. In the present embodiment, the mold 160 made of metal is attached to the mold opening and closing unit 130. A material of the mold 160 is not limited to metal, and the mold 160 may be made of resin or ceramic. The mold 160 of metal is referred to as a metal mold. The mold opening and closing unit 130 rotates a ball screw 132 by driving a mold drive unit 131 implemented by a motor under the control of the control unit 500, thereby opening and closing the mold 160. The configuration of the mold 160 will be described later.

The injection unit 100 is a unit that injects a material of a molded article into the mold 160. A hopper 30 into which a material of a molded article is put is coupled to the injection unit 100. A thermoplastic resin formed in a pellet form is used as the material for the molded article. Examples of the thermoplastic resin include acrylonitrile butadiene styrene (ABS), polycarbonate (PC), polyacetal (POM), polypropylene (PP), and polybutylene terephthalate (PBT). The material of a molded article may contain metal or ceramic in addition to the thermoplastic resin. The supply of the material to the injection unit 100 is not limited to the supply from the hopper 30, and may be performed, for example, via a tube through which the material is pumped.

The injection unit 100 plasticizes at least a part of the material supplied from the hopper 30 to generate a plasticized material and injects the generated plasticized material into a cavity defined in the mold 160. In the present specification, "plasticizing" is a concept including melting and refers to changing from a solid state to a state having fluidity. Specifically, in a case of a material in which glass transition occurs, plasticizing refers to setting a temperature of the material to a glass transition point or higher. In the case of a material in which glass transition does not occur, "plasticizing" refers to setting a temperature of the material to a temperature equal to or higher than a melting point.

FIG. 2 is a cross-sectional view illustrating a schematic configuration of the injection unit 100. The injection unit 100 includes a plasticizing unit 110, a flow path 116, and an injector 120.

The plasticizing unit 110 plasticizes at least a part of the material to generate a plasticized material. Hereinafter, the plasticized material may be simply referred to as a material. The plasticizing unit 110 includes a screw 111, a barrel 112, and a barrel heater 113.

The screw 111 is accommodated in an accommodation portion 101. The screw 111 is rotated by a motor 118 about a drive shaft 119 of the motor 118 in the accommodation portion 101. A center axis RX serving as a rotation center of the screw 111 coincides with a center of the drive shaft 119 of the motor 118 in an XZ plane. In the present embodiment, axial directions of the drive shaft 119 and the center axis RX are along the Y direction. The rotation of the screw 111 by the motor 118 is controlled by the control unit 500. The screw 111 may be driven by the motor 118 via a decelerator.

A communication hole 115 is formed at a center of the barrel 112. The communication hole 115 communicates with the flow path 116. A cylinder 121 and a nozzle 114, which will be described later, are coupled to the flow path 116. In the flow path 116, a check valve 124 is provided upstream of the cylinder 121. The check valve 124 prevents a backflow of the plasticized material from the cylinder 121 toward the screw 111.

The barrel heater 113 heats the barrel 112. The heating by the barrel heater 113 is controlled by the control unit 500.

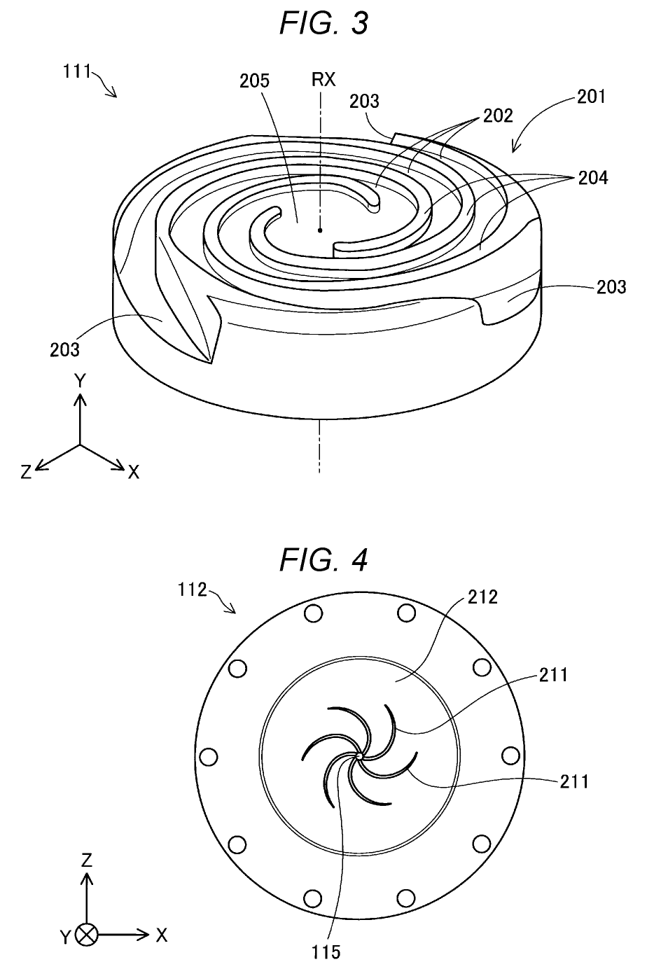

FIG. 3 is a perspective view illustrating a schematic configuration of the screw 111. The screw 111 has a substantially cylindrical shape in which a length in a direction along the center axis RX is smaller than a length in a direction perpendicular to the center axis RX. The screw 111 is also called a flat screw. Vortex grooves 202 are formed around a central portion 205 in a groove forming surface 201 of the screw 111 facing the barrel 112. The grooves 202 respectively communicate with material inlets 203 formed in a side surface of the screw 111. The material supplied from the hopper 30 is supplied to the grooves 202 through the material inlets 203. The grooves 202 are formed by being separated by protruding ridge portions 204. FIG. 3 illustrates an example in which three grooves 202 are formed, but the number of grooves 202 may be one, or may be two or more. The grooves 202 do not necessarily have vortex shapes, and may have spiral shapes or shapes of involute curves, or may have shapes extending arcuately from the central portion 205 toward the outer periphery.

FIG. 4 is a schematic plan view illustrating the barrel 112. The barrel 112 has a facing surface 212 facing the groove forming surface 201 of the screw 111. The communication hole 115 communicating with the flow path 116 is formed at a center of the facing surface 212. The facing surface 212 is formed with a plurality of guide grooves 211 that are coupled to the communication hole 115 and extend in a shape of a vortex from the communication hole 115 toward an outer periphery. The guide grooves 211 may be not necessarily provided in the barrel 112. Further, the guide grooves 211 may be not necessarily coupled to the communication hole 115.

The material supplied to the grooves 202 of the screw 111 is plasticized between the screw 111 and the barrel 112 along with rotation of the screw 111 and by the heating of the barrel heater 113. The material flows along the groove 202 and the guide groove 211 by the rotation of the screw 111 while being plasticized, and is guided to the central portion 205 of the screw 111. The material flowing into the central portion 205 flows out from the communication hole 115 provided at the center of the barrel 112 to the flow path 116 communicating with the plasticizing unit 110, and flows through the flow path 116.

The injector 120 injects the material in the flow path 116 into the mold 160. As illustrated in FIG. 2, the injector 120 includes a cylinder 121 that communicates with the nozzle 114 and is coupled to the flow path 116 through which the plasticized material flows, a plunger 122 that moves in the cylinder 121, and a plunger drive unit 123. The cylinder 121 has a substantially cylindrical shape. The cylinder 121 is also called a sleeve. The plunger 122 has a substantially columnar shape. The plunger drive unit 123 includes a ball screw 126 that moves the plunger 122 along a longitudinal direction of the plunger 122, and a motor 127 that drives the ball screw 126. In the present embodiment, when the ball screw 126 is driven by the motor 127, the plunger 122 coupled to the ball screw 126 is moved forward or rearward. "Forward" refers to a direction in which the plunger 122 moves close to the flow path 116. "Rearward" refers to a direction in which the plunger 122 moves away from the flow path 116.

In the injector 120, the plunger drive unit 123 is controlled by the control unit 500 to perform a measurement operation and an injection operation. The measurement operation is an operation of suctioning the plasticized material from the flow path 116 into the cylinder 121 by moving the plunger 122 rearward. The injection operation is an operation of sending the plasticized material suctioned into the cylinder 121 to the nozzle 114 by moving the plunger 122 forward. The control unit 500 controls an injection amount, an injection speed, and injection pressure of the plasticized material from the nozzle 114 by adjusting a movement amount and a movement speed of the plunger 122 in the measurement operation and the injection operation.

In the present embodiment, the nozzle 114 is implemented as a hot runner nozzle. The nozzle 114 is disposed in the mold 160. A nozzle heater 117 that heats the nozzle 114 is disposed around the nozzle 114. The control unit 500 controls the nozzle heater 117 to adjust a temperature of the material flowing in the nozzle 114.

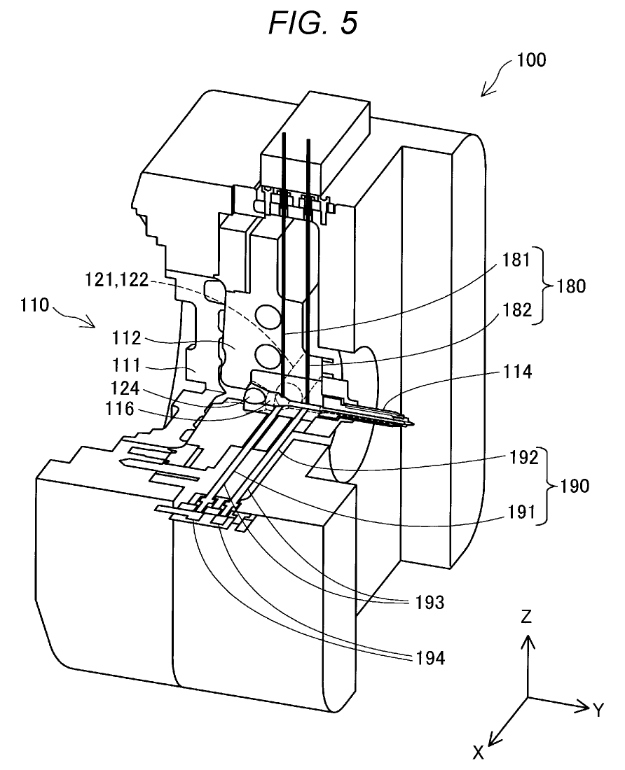

FIG. 5 is a perspective one-side cross-sectional view illustrating an internal structure of the injection unit 100. In FIG. 5, hatching is omitted in each cross section. The injection unit 100 includes a temperature measurement unit 180 and a pressure measurement unit 190. The temperature measurement unit 180 is at least partially exposed in the flow path 116 and measures the temperature of the material in the flow path 116. The pressure measurement unit 190 is at least partially exposed in the flow path 116 and measures pressure of the material in the flow path 116.

The temperature measurement unit 180 includes a first temperature measurement unit 181 and a second temperature measurement unit 182. The first temperature measurement unit 181 is mainly used to measure a first temperature that is a temperature of the plasticized material flowing into the flow path 116 from the plasticizing unit 110. The second temperature measurement unit 182 is mainly used to measure a second temperature that is a temperature of the plasticized material injected from the flow path 116 to the mold 160 through the nozzle 114.

The pressure measurement unit 190 includes a first pressure measurement unit 191 and a second pressure measurement unit 192. The first pressure measurement unit 191 is mainly used to measure first pressure that is pressure of the plasticized material flowing into the flow path 116 from the plasticizing unit 110. The second pressure measurement unit 192 is mainly used to measure second pressure that is pressure of the plasticized material injected from the flow path 116 to the mold 160 through the nozzle 114.

In the flow path 116, the second temperature measurement unit 182 is located downstream of the first temperature measurement unit 181. In the flow path 116, the second pressure measurement unit 192 is located downstream of the first pressure measurement unit 191. Hereinafter, when the first temperature measurement unit 181 and the second temperature measurement unit 182 are not particularly distinguished, they are simply referred to as the temperature measurement unit 180. When the first pressure measurement unit 191 and the second pressure measurement unit 192 are not particularly distinguished, they are simply referred to as the pressure measurement unit 190. The temperature measurement unit 180 in the present embodiment includes a temperature measurement resistor. The temperature measurement resistor has a feature that a resistance value linearly increases with respect to a temperature rise.

The temperature measurement unit 180 has a rod-like shape. The temperature measurement unit 180 penetrates to the inside of the flow path 116 through a through hole formed in a housing of the injection molding apparatus 10 and the barrel 112, and a tip end of the temperature measurement unit 180 is exposed to the inside of the flow path 116. A diameter of a tip end portion of the temperature measurement unit 180 is, for example, 1 mm. A resistance element made of platinum or the like is disposed in the tip end of the temperature measurement unit 180, and an internal conductive wire coupled to the resistance element extends to a rear end of the temperature measurement unit 180 and is coupled to the control unit 500.

The pressure measurement unit 190 includes a rod 193 having a rod shape and a displacement sensor 194 that comes into contact with a rear end of the rod 193. A diameter of a tip end portion of the rod 193 is, for example, 3 mm. The displacement sensor 194 measures a movement amount of the rod 193 along a longitudinal direction of the rod 193. The displacement sensor 194 is coupled to the control unit 500. The pressure measurement unit 190 measures pressure corresponding to a movement amount of the rod 193 by the displacement sensor 194 detecting a movement amount of the rod 193 along the longitudinal direction caused by the pressure of the material in the flow path 116.

In the present embodiment, an extending direction of each of the first temperature measurement unit 181 and the second temperature measurement unit 182 is the -Z direction. An extending direction of each of the first pressure measurement unit 191 and the second pressure measurement unit 192 is the -X direction. A tip end of the first temperature measurement unit 181 and a tip end of the first pressure measurement unit 191 are on a concentric circle centered on a center axis of the flow path 116. A tip end of the second temperature measurement unit 182 and a tip end of the second pressure measurement unit 192 are on a concentric circle centered on the center axis of the flow path 116. A tip end of the first pressure measurement unit 191 and a tip end of the plunger 122 are in a facing positional relationship. In the present embodiment, the tip end of the first temperature measurement unit 181 and the tip end of the first pressure measurement unit 191 are disposed in the vicinity of a coupling portion between the cylinder 121 and the flow path 116 in the flow path 116. The tip end of the second temperature measurement unit 182 and the tip end of the second pressure measurement unit 192 are disposed between a tip end of the nozzle 114 and the coupling portion between the cylinder 121 and the flow path 116 in the flow path 116. In the present embodiment, a diameter of the flow path 116 at a portion where the tip end of the first temperature measurement unit 181 and the tip end of the first pressure measurement unit 191 are exposed is larger than a diameter of the flow path 116 at a portion where the tip end of the second temperature measurement unit 182 and the tip end of the second pressure measurement unit 192 are exposed.

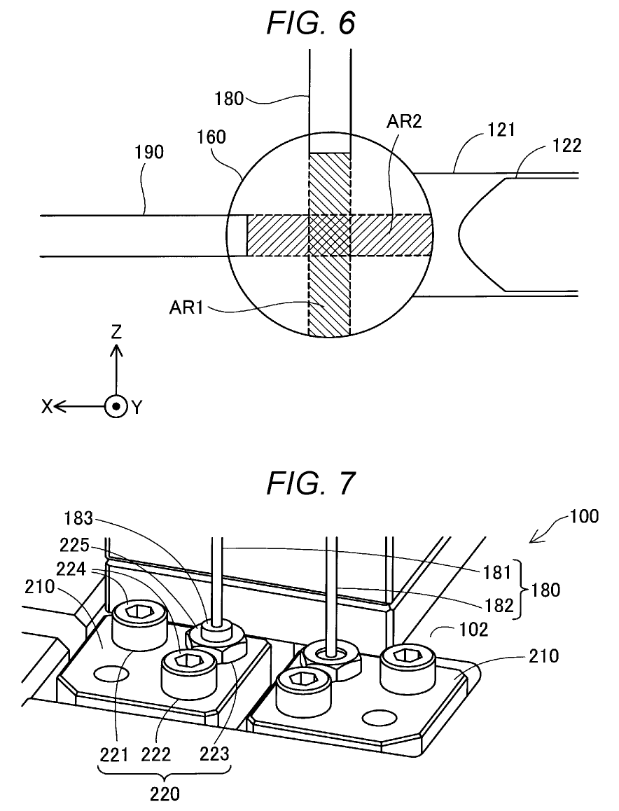

FIG. 6 is a view illustrating an arrangement of the temperature measurement unit 180 and the pressure measurement unit 190. In FIG. 6, a region in which the temperature measurement unit 180 virtually extends in the flow path 116 along an extending direction of the temperature measurement unit 180 is illustrated as a first virtual region AR1. In addition, a region in which the pressure measurement unit 190 virtually extends in the flow path 116 along an extending direction of the pressure measurement unit 190 is illustrated as a second virtual region AR2. In the present embodiment, at least a part of the first virtual region AR1 and at least a part of the second virtual region AR2 overlap each other in the flow path 116. FIG. 6 illustrates a state in which at least a part of the first virtual region AR1 and at least a part of the second virtual region AR2 overlap each other when viewed along an extending direction of the flow path 116. At least a part of the first virtual region AR1 and at least a part of the second virtual region AR2 also overlap each other when viewed from a direction orthogonal to the extending direction of the flow path 116. As described above, in the present embodiment, since the temperature measurement unit 180 and the pressure measurement unit 190 are disposed such that at least a part of the first virtual region AR1 and at least a part of the second virtual region AR2 overlap each other in the flow path 116, it is possible to substantially align a temperature measurement location and a pressure measurement location in the flow path 116.

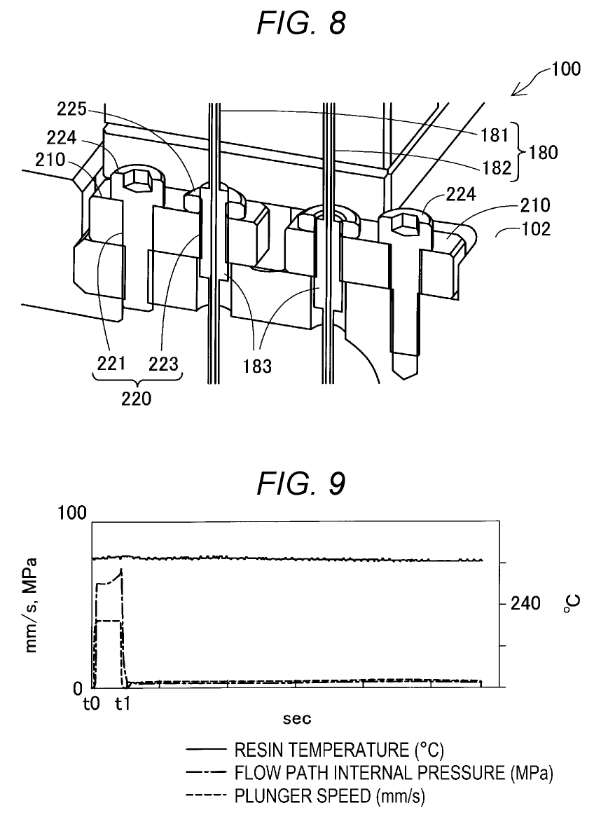

FIGS. 7 and 8 are views illustrating a configuration of a fixing portion 210 for fixing the temperature measurement unit 180. The injection unit 100 includes the fixing portion 210 for fixing the temperature measurement unit 180. The fixing portion 210 is configured as a separate body from a housing 102 of the injection unit 100, and is detachable from the housing 102 of the injection unit 100. The fixing portion 210 has a plurality of screw holes 220. The plurality of screw holes 220 include a first screw hole 221, a second screw hole 222, and a third screw hole 223. The first screw hole 221 and the second screw hole 222 are screw holes for detachably fixing the fixing portion 210 to the housing 102 of the injection unit 100 by fixing screws 224. The third screw hole 223 is a screw hole for fixing the temperature measurement unit 180 to the fixing portion 210. A male screw portion 183 formed with a male screw is provided near a rear end portion of the temperature measurement unit 180. The temperature measurement unit 180 is fixed to the fixing portion 210 by screwing the male screw portion 183 into the third screw hole 223. It is possible to adjust an exposure amount at which the tip end of the temperature measurement unit 180 is exposed in the flow path 116 by adjusting a screwing amount of the male screw portion 183 into the third screw hole 223. A nut 225 is screwed into an upper end portion of the male screw portion 183 from above the third screw hole 223. By screwing the nut 225 into the upper end of the male screw portion 183, rotation of the temperature measurement unit 180 in the third screw hole 223 can be prevented, and fluctuation of a tip end position of the temperature measurement unit 180 in the flow path 116 can be prevented. According to such a structure, even when there is an airframe difference such as a dimensional error in the temperature measurement unit 180, the airframe difference can be absorbed, and thus the temperature measurement unit 180 can stably perform temperature measurement.

FIG. 9 is a diagram illustrating an example of a measurement result of the temperature and the pressure of the plasticized material in the flow path 116 by the temperature measurement unit 180 and the pressure measurement unit 190. In a graph illustrated in FIG. 9, a horizontal axis represents time, and vertical axes represent a temperature and pressure in the flow path 116, and a movement speed of the plunger 122. The temperature is measured by the second temperature measurement unit 182, and the pressure is measured by the second pressure measurement unit 192. On the time axis, an injection operation is started at a timing t0, and a measurement operation is started at a timing t1. A speed at which the plunger 122 is moved forward during the injection operation is about 10 times a speed at which the plunger 122 is moved rearward during the measurement operation. A temperature of the barrel 112 is adjusted to 240° C. by controlling the barrel heater 113. A peak of the pressure immediately before the end of the injection operation is present in the graph because the inside of the mold 160 is filled with the plasticized material. Due to the influence of shear heat generation when the plasticized material is pressure-fed in the cylinder 121 and the flow path 116, the temperature of the plasticized material is a highest temperature immediately before the end of the injection operation. When the measurement operation is started, the temperature of the plasticized material is slightly lowered because there is no influence of the shear heat generation.

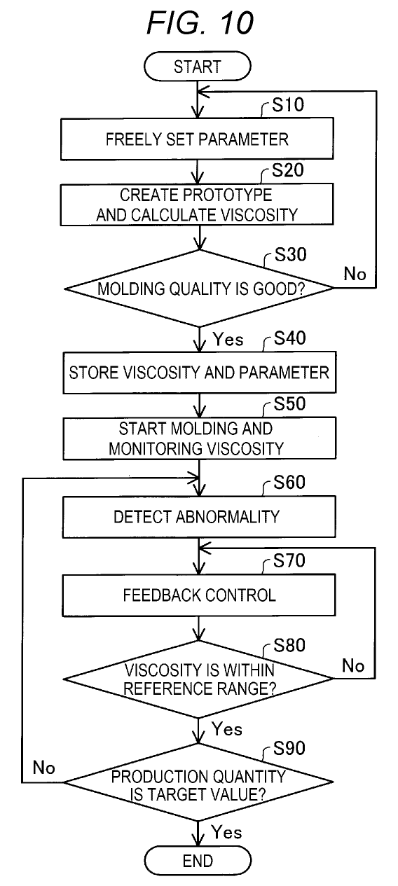

FIG. 10 is a flowchart illustrating parameter setting processing executed by the control unit 500. The parameter setting processing is processing for setting each parameter used by the injection molding apparatus 10 for injection molding of a molded article.

In step S10, the control unit 500 freely sets each parameter related to injection molding. In the present embodiment, parameters related to injection molding include a temperature of the barrel heater 113, a movement speed of the plunger 122, a rotation speed of the screw 111, and a temperature of the nozzle heater 117. When step S10 is executed for the first time, for example, initial setting values stored in the control unit 500 are set as these parameters.

In step S20, the control unit 500 controls the temperature of the barrel heater 113, the movement speed of the plunger 122, the rotation speed of the screw 111, and the temperature of the nozzle heater 117 using the parameters set in step S10, and creates a prototype of the molded article. In step S20, the control unit 500 measures the viscosity of the plasticized material using the temperature measured by the temperature measurement unit 180 and the pressure measured by the pressure measurement unit 190. The control unit 500 can calculate the viscosity of the plasticized material based on a known Cross-WLF viscosity model. In the present embodiment, the temperature measured by the second temperature measurement unit 182 of the temperature measurement unit 180 and the pressure measured by the second pressure measurement unit 192 of the pressure measurement unit 190 are used to calculate the viscosity.

In step S30, it is determined whether molding quality of the prototype molded in step S20 is good. In step S30, for example, the prototype is imaged by a camera coupled to the control unit 500, and the control unit 500 determines whether the molding quality is good by performing visual inspection on the prototype based on the imaged image. In the visual inspection, for example, the presence or absence of burrs, stringiness, short circuit, void, and crack generated in the prototype is inspected. In step S30, an operator may determine the molding quality by visual inspection instead of the control unit 500.

When it is determined in step S30 that the molding quality of the prototype is not good, the control unit 500 returns the processing to step S10 and changes the parameters related to injection molding. Then, the control unit 500 repeats the processing of step S20 and step S30 until it is determined in step S30 that the molding quality is good.

When it is determined in step S30 that the molding quality of the prototype is good, in step S40, the control unit 500 stores, as thresholds, the viscosity calculated in step S20 and the parameters used when the viscosity is calculated in the storage unit 520 provided in the control unit 500.

In step S50, the control unit 500 controls the injection molding apparatus 10 to start molding of the molded article. The molding refers to mass production of the molded article by injection molding. In step S50, the control unit 500 further starts monitoring the viscosity of the plasticized material. The control unit 500 sequentially performs measurement of a temperature by the temperature measurement unit 180 and measurement of pressure by the pressure measurement unit 190, and monitors the viscosity by sequentially calculating the viscosity of the plasticized material by the same method as in step S20 described above using the measured temperature and pressure.

In step S60, the control unit 500 performs abnormality detection. In the abnormality detection, the control unit 500 detects, for example, an abnormality in the temperature measured by the temperature measurement unit 180 or the pressure measured by the pressure measurement unit 190. When an abnormality is detected, the control unit 500 controls the injection molding apparatus 10 to stop the molding of the molded article.

In step S70, the control unit 500 performs feedback control of each parameter according to the temperature measured by the temperature measurement unit 180 and the pressure measured by the pressure measurement unit 190.

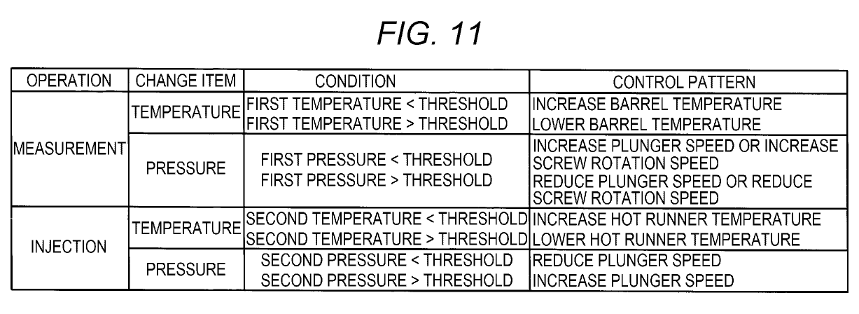

FIG. 11 is a diagram illustrating a control pattern of the feedback control executed in step S70. For example, when the first temperature measured by the first temperature measurement unit 181 during the measurement operation is lower than a threshold stored in the storage unit 520, the control unit 500 controls the barrel heater 113 to increase the temperature of the barrel 112. When the first temperature measured by the first temperature measurement unit 181 during the measurement operation exceeds the threshold stored in the storage unit 520, the control unit 500 controls the barrel heater 113 to lower the temperature of the barrel 112. When the first pressure measured by the first pressure measurement unit 191 during the measurement operation is lower than a threshold stored in the storage unit 520, the control unit 500 increases a speed at which the plunger 122 is moved rearward or increases the rotation speed of the screw 111. When the first pressure measured by the first pressure measurement unit 191 during the measurement operation exceeds the threshold stored in the storage unit 520, the control unit 500 reduces the speed at which the plunger 122 is moved rearward or reduces the rotation speed of the screw 111. When the second temperature measured by the second temperature measurement unit 182 during the injection operation is lower than a threshold stored in the storage unit 520, the control unit 500 controls the nozzle heater 117 to increase the temperature of the nozzle 114 to increase the temperature of the hot runner. When the second temperature measured by the second temperature measurement unit 182 during the injection operation exceeds the threshold stored in the storage unit 520, the control unit 500 controls the nozzle heater 117 to lower the temperature of the nozzle 114 to lower the temperature of the hot runner. When the second pressure measured by the second pressure measurement unit 192 during the injection operation is lower than a threshold stored in the storage unit 520, the control unit 500 reduces a speed at which the plunger 122 is moved forward. When the second pressure measured by the second pressure measurement unit 192 during the injection operation is larger than the threshold stored in the storage unit 520, the control unit 500 increases the speed at which the plunger 122 is moved forward.

In step S80 of FIG. 10, the control unit 500 determines whether the monitored viscosity is within a reference range. The reference range is a certain range including the viscosity stored in step S40. The reference range is, for example, a range of ±5% of the viscosity stored in step S40. When the control unit 500 determines that the viscosity is not within the reference range, the control unit 500 returns the processing to step S70 and adjusts the parameters illustrated in FIG. 11 until the viscosity falls within the reference range.

In step S90, the control unit 500 determines whether the production quantity of molded articles produced in the molding reaches a target value. When counting the production quantity, the control unit 500 preferably subtracts the number of molded articles produced during a period in which the viscosity falls out of the reference range from the production quantity. When it is determined that the production quantity reaches the target value, the control unit 500 ends the parameter adjustment processing, and when it is determined that the production quantity does not reach the target value, the control unit 500 returns the processing to step S50 and continues the molding of the molded article.

According to the injection molding apparatus 10 in the first embodiment described above, since at least a part of the temperature measurement unit 180 and at least a part of the pressure measurement unit 190 are exposed in the flow path 116, the temperature and the pressure of the material in the flow path 116 can be directly measured. In the present embodiment, as illustrated in FIG. 6, at least a part of the first virtual region AR1 in which the temperature measurement unit 180 virtually extends in the flow path 116 and at least a part of the second virtual region AR2 in which the pressure measurement unit 190 virtually extends in the flow path 116 overlap each other. Therefore, it is possible to bring measurement locations close to each other while exposing both the temperature measurement unit 180 and the pressure measurement unit 190 in the flow path 116, and thus it is possible to accurately acquire values of the temperature and the pressure at a target measurement position. As a result, since the viscosity can be accurately calculated, molding quality can be improved by feedback-controlling the temperature of the material and an injection speed so that the viscosity falls within the reference range.

In the present embodiment, the control unit 500 calculates the viscosity of the material based on a value of the pressure measured by the pressure measurement unit 190 and a value of the temperature measured by the temperature measurement unit 180. Therefore, the viscosity of the material can be accurately calculated using both the temperature and the pressure of the material.

Further, in the present embodiment, the injection unit 100 includes a plurality of the temperature measurement units 180 including the first temperature measurement unit 181 and the second temperature measurement unit 182, and a plurality of the pressure measurement units 190 including the first pressure measurement unit 191 and the second pressure measurement unit 192. In the flow path 116, the second temperature measurement unit 182 is located downstream of the first temperature measurement unit 181, and the second pressure measurement unit 192 is located downstream of the first pressure measurement unit 191. Therefore, temperatures and pressures at a plurality of measurement locations can be measured.

In the present embodiment, the temperature measurement unit 180 that measures the temperature of the material includes a temperature measurement resistor. Therefore, as illustrated in FIG. 9, it is possible to perform temperature measurement with higher responsiveness and higher accuracy than the case of measuring a temperature using a thermocouple in which an error is likely to occur in a range of 250 degrees to 550 degrees due to a phenomenon called short range ordering. As a result, since the viscosity can be accurately calculated, quality of the molded article can be improved.

Further, in the present embodiment, the temperature measurement unit 180 is fixed to the injection unit 100 by the fixing portion 210 having the screw hole 220, and the temperature measurement unit 180 is fixed to the fixing portion 210 by being screwed into the screw hole 220. Therefore, the temperature measurement unit 180 can be fixed to the injection unit 100 with a simple structure.

Further, in the present embodiment, the fixing portion 210 is configured as a separate body from the housing 102 of the injection unit 100, and is detachable from the housing 102. Therefore, since the temperature measurement unit 180 can be attached to and detached from the injection unit 100 using the fixing portion 210, it is possible to reduce the possibility that the temperature measurement unit 180 is damaged when the temperature measurement unit 180 is attached and detached.

### B. Other Embodiments

(B1) In the feedback control in step S70 of FIG. 10, the control unit 500 is not limited to the control illustrated in FIG. 11, and can perform other control. For example, the control unit 500 obtains at least one of a temperature difference that is a difference between a value of the first temperature measured by the first temperature measurement unit 181 and a value of the second temperature measured by the second temperature measurement unit 182 and a pressure difference that is a difference between a value of the pressure measured by the first pressure measurement unit 191 and a value of the pressure measured by the second pressure measurement unit 192. Then, the control unit 500 may control the injection unit 100 based on at least one of the calculated temperature difference and pressure difference. In this manner, the control unit 500 can control the injection unit 100 according to a change in the temperature or the pressure in the flow path 116.

For example, the control unit 500 may control the temperature of the nozzle 114 based on the temperature difference. In this manner, since the temperature of the nozzle 114 can be controlled based on the temperature difference between the first temperature and the second temperature measured at different measurement locations, the temperature of the injected material can be accurately controlled. Further, the control unit 500 may control the injector 120, that is, the plunger 122 based on the pressure difference. In this manner, since the injector 120 can be controlled based on the pressure difference between the first pressure and the second pressure measured at different measurement locations, the pressure of the injected material can be accurately controlled.

Specifically, for example, the control unit 500 obtains a value obtained by subtracting a value of the second temperature from a value of the first temperature as the temperature difference, and when the temperature difference is a positive value, the control unit 500 increases the temperature of the nozzle heater 117 to increase the temperature of the nozzle 114 as the temperature difference increases. For example, when the temperature difference is a negative value, the control unit 500 increases the temperature of the barrel heater 113 to increase the temperature of the plasticized material flowing into the flow path 116 as an absolute value of the temperature difference increases. In this manner, even when the temperature in the flow path 116 changes more than expected, it is possible to accurately control the temperature of the material by controlling the injection unit 100 according to the temperature difference between the first temperature and the second temperature.

For example, the control unit 500 obtains a value obtained by subtracting a value of the second pressure from a value of the first pressure as the pressure difference during the injection operation of the plunger 122. For example, the control unit 500 increases a movement speed of the plunger 122 provided in the injector 120 as the pressure difference increases. In this manner, even when the pressure in the flow path 116 changes more than expected, it is possible to accurately control the pressure of the material by controlling the injection unit 100 according to the pressure difference between the first pressure and the second pressure.

In the control using the temperature difference or the pressure difference described above, the control unit 500 preferably controls the nozzle heater 117 or the plunger drive unit 123 such that the viscosity calculated using the second temperature measured by the second temperature measurement unit 182 and the second pressure measured by the second pressure measurement unit 192 falls within the reference range of the viscosity described above.

(B2) In the embodiment described above, the temperature measurement unit 180 is fixed to the injection unit 100 via the fixing portion 210. On the other hand, the temperature measurement unit 180 may be directly fixed to the injection unit 100. Further, in the embodiment described above, the temperature measurement unit 180 is configured to be detachable from the injection unit 100 using the fixing portion 210. On the other hand, the temperature measurement unit 180 may be provided in a manner of being undetachable from the injection unit 100.

(B3) In the embodiment described above, the temperature measurement unit 180 includes the temperature measurement resistor as a temperature measurement element. On the other hand, the temperature measurement unit 180 may include a thermocouple or a thermistor as the temperature measurement element.

(B4) In the embodiment described above, the control unit 500 calculates the viscosity using both the measured temperature and the measured pressure. On the other hand, the control unit 500 may calculate the viscosity using one of the measured temperature and the measured pressure.

(B5) In the embodiment described above, the injection unit 100 includes the two temperature measurement units 180 and the two pressure measurement units 190. On the other hand, the injection unit 100 may include one temperature measurement unit 180 and one pressure measurement unit 190, or three or more temperature measurement units 180 and three or more pressure measurement units 190. The injection unit 100 may include different numbers of the temperature measurement units 180 and the pressure measurement units 190.

### C. Other aspects

The present disclosure is not limited to the embodiments described above, and may be implemented with various configurations without departing from the spirit and scope of the present disclosure. For example, technical features in the embodiments corresponding to technical features in the respective aspects described below can be replaced or combined as appropriate in order to solve a part or all of the above-described problems or in order to achieve a part or all of the above-described effects. Further, the technical features can be deleted as appropriate unless described as essential features in the present specification.

(1) According to a first aspect of the present disclosure, there is provided an injection molding apparatus that performs injection molding of a molded article using a mold. The injection molding apparatus includes: an injection unit configured to inject a material of the molded article into the mold; a mold opening and closing unit to which the mold is attached and that opens and closes the mold; and a control unit configured to control the injection unit and the mold opening and closing unit, in which the injection unit includes a plasticizing unit that plasticizes the material, a flow path that communicates with the plasticizing unit and through which the plasticized material flows, an injector that injects the material in the flow path into the mold, a temperature measurement unit that is at least partially exposed in the flow path and measures a temperature of the material, and a pressure measurement unit that is at least partially exposed in the flow path and measures pressure of the material, and at least a part of a region in which the temperature measurement unit virtually extends in the flow path and at least a part of a region in which the pressure measurement unit virtually extends in the flow path overlap each other in the flow path.

According to such an aspect, since measurement locations can be brought close to each other while exposing both the temperature measurement unit and the pressure measurement unit in the flow path, values of a temperature and pressure at a target measurement position can be accurately acquired.

(2) In the above aspect, the control unit may calculate viscosity of the material based on a value of the pressure measured by the pressure measurement unit and a value of the temperature measured by the temperature measurement unit. According to such an aspect, the viscosity of the material can be accurately calculated by using both the value of the pressure and the value of the temperature.

(3) In the above aspect, the injection unit may include a plurality of the temperature measurement units including a first temperature measurement unit and a second temperature measurement unit, and a plurality of the pressure measurement units including a first pressure measurement unit and a second pressure measurement unit, and in the flow path, the second temperature measurement unit may be located downstream of the first temperature measurement unit, and the second pressure measurement unit may be located downstream of the first pressure measurement unit. According to such an aspect, the temperature and the pressure can be measured at a plurality of measurement locations.

(4) In the above aspect, the control unit may control the injection unit based on at least one of a temperature difference that is a difference between a value of a first temperature measured by the first temperature measurement unit and a value of a second temperature measured by the second temperature measurement unit, and a pressure difference that is a difference between a value of first pressure measured by the first pressure measurement unit and a value of second pressure measured by the second pressure measurement unit. According to such an aspect, the injection unit can be controlled according to a change in the temperature or the pressure in the flow path.

(5) In the above aspect, the injection unit may include a nozzle provided between the flow path and the mold, and the control unit may control a temperature of the nozzle based on the temperature difference. According to such an aspect, the temperature of the injected material can be accurately controlled by controlling the temperature of the nozzle based on the temperature difference between the first temperature and the second temperature measured at different measurement locations.

(6) In the above aspect, the control unit may control the injector based on the pressure difference. According to such an aspect, the pressure of the injected material can be accurately controlled by controlling the injector based on the pressure difference between the first pressure and the second pressure measured at different measurement locations.

(7) In the above aspect, the temperature measurement unit may include a temperature measurement resistor. According to such an aspect, the temperature in the flow path can be accurately measured as compared with a case of using a temperature measurement unit including a thermocouple.

(8) In the above aspect, the injection unit may include a fixing portion that has a screw hole and fixes the temperature measurement unit, and the temperature measurement unit may be fixed to the fixing portion by being screwed into the screw hole. According to such an aspect, the temperature measurement unit can be fixed with a simple structure.

(9) In the aspect described above, the fixing portion may be configured as a separate body from a housing of the injection unit and may be detachable from the housing. According to such an aspect, it is possible to reduce the possibility that the temperature measurement unit is damaged when the temperature measurement unit is attached or detached.

(10) According to a second aspect of the present disclosure, there is provided an injection unit. The injection unit includes: a plasticizing unit configured to plasticize a material; a flow path that communicates with the plasticizing unit and through which the plasticized material flows; an injector configured to inject the material in the flow path into a mold; a temperature measurement unit that is at least partially exposed in the flow path and is configured to measure a temperature of the material; and a pressure measurement unit that is at least partially exposed in the flow path and is configured to measure pressure of the material, in which at least a part of a region in which the temperature measurement unit virtually extends in the flow path and at least a part of a region in which the pressure measurement unit virtually extends in the flow path overlap each other in the flow path.

The present disclosure can be implemented in various aspects such as a computer program and a non-transitory tangible recording medium in which the computer program is recorded in a manner of being readable by a computer, in addition to the aspects of the injection molding apparatus and the injection unit described above.

What is claimed is:

1. An injection molding apparatus that performs injection molding of a molded article using a mold, the injection molding apparatus comprising:
an injection unit configured to inject a material of the molded article into the mold;
a mold opening and closing unit to which the mold is attached and that opens and closes the mold; and
a control unit configured to control the injection unit and the mold opening and closing unit, wherein
the injection unit includes
a plasticizing unit that plasticizes the material,
a flow path that communicates with the plasticizing unit and through which the plasticized material flows,
an injector that injects the material in the flow path into the mold,
a temperature measurement unit that is at least partially exposed in the flow path and measures a temperature of the material, and
a pressure measurement unit that is at least partially exposed in the flow path and measures a pressure of the material, and
at least a part of a region in which the temperature measurement unit virtually extends in the flow path and at least a part of a region in which the pressure measurement unit virtually extends in the flow path overlap each other in the flow path.

2. The injection molding apparatus according to claim 1, wherein
the control unit calculates a viscosity of the material based on a value of the pressure measured by the pressure measurement unit and a value of the temperature measured by the temperature measurement unit.

3. The injection molding apparatus according to claim 1, wherein
the injection unit includes
a plurality of the temperature measurement units including a first temperature measurement unit and a second temperature measurement unit, and
a plurality of the pressure measurement units including a first pressure measurement unit and a second pressure measurement unit, and
in the flow path,
the second temperature measurement unit is located downstream of the first temperature measurement unit, and
the second pressure measurement unit is located downstream of the first pressure measurement unit.

4. The injection molding apparatus according to claim 3, wherein
the control unit controls the injection unit based on at least one of a temperature difference that is a difference between a value of a first temperature measured by the first temperature measurement unit and a value of a second temperature measured by the second temperature measurement unit, and a pressure difference that is a difference between a value of a first pressure measured by the first pressure measurement unit and a value of a second pressure measured by the second pressure measurement unit.

5. The injection molding apparatus according to claim 4, wherein
the injection unit includes a nozzle provided between the flow path and the mold, and
the control unit controls a temperature of the nozzle based on the temperature difference.

6. The injection molding apparatus according to claim 4, wherein
the control unit controls the injector based on the pressure difference.

7. The injection molding apparatus according to claim 1, wherein
the temperature measurement unit includes a temperature measurement resistor.

8. The injection molding apparatus according to claim 1, wherein
the injection unit includes a fixing portion that has a screw hole and fixes the temperature measurement unit, and
the temperature measurement unit is fixed to the fixing portion by being screwed into the screw hole.

9. The injection molding apparatus according to claim 8, wherein
the fixing portion is configured as a separate body from a housing of the injection unit and is detachable from the housing.

10. An injection unit comprising:
a plasticizing unit configured to plasticize a material;
a flow path that communicates with the plasticizing unit and through which the plasticized material flows;
an injector configured to inject the material in the flow path into a mold;
a temperature measurement unit that is at least partially exposed in the flow path and is configured to measure a temperature of the material; and
a pressure measurement unit that is at least partially exposed in the flow path and is configured to measure a pressure of the material, wherein
at least a part of a region in which the temperature measurement unit virtually extends in the flow path and at least a part of a region in which the pressure measurement unit virtually extends in the flow path overlap each other in the flow path.
